(19) United States
(12) Patent Application Publication
(10) Pub. No.: US 2026/0063090 A1
(43) Pub. Date: Mar. 5, 2026

(54) APPARATUS AND METHOD FOR OPERATING AN INTERNAL COMBUSTION ENGINE WITH MULTIPLE COMBUSTION MODES

(71) Applicant: HPDI Technology Limited Partnership, Vancouver (CA)

(72) Inventors: Jian Huang, Surrey (CA); Sandeep Munshi, Vancouver (CA)

(21) Appl. No.: 19/130,366

(22) PCT Filed: Nov. 17, 2023
(86) PCT No.: PCT/CA2023/051553

§ 371 Date: May 15, 2025

Related U.S. Application Data
(60) Provisional application No. 63/426,675, filed on Nov. 18, 2022.

(51) Int. Cl. F02D 41/30; F02D 1/16; F02D 19/02

(52) U.S. Cl. CPC F02D 41/3017; F02D 1/16; F02D 19/022; F02D 41/3076; F02D 2200/0602; F02D 2250/31

(57) ABSTRACT

An apparatus and method for operating an engine in multiple combustion modes includes storing a gaseous fuel as a compressed gas; the engine is operated in a first combustion mode when an injection or storage pressure of the gaseous fuel is greater than or equal to a threshold pressure, the engine is operated in a second combustion mode when the injection or storage pressure is less than the threshold pressure; in the first combustion mode, the gaseous fuel substantially burns by diffusion combustion; and in the second combustion mode, the gaseous fuel substantially burns by one of partially-premixed combustion and premixed combustion.

### TECHNICAL FIELD

The present application relates to operating an internal combustion engine with multiple combustion modes, and particularly when the internal combustion engine is fueling with a gaseous fuel stored as a compressed gas.

### BACKGROUND

Gaseous fuels, such as hydrogen, are promising fuels for addressing carbon dioxide (CO₂) reduction objectives in industry, particularly the transportation industry. A gaseous fuel is any fuel that is in the gas state at standard temperature and pressure, which is defined herein as a temperature of 0 degrees Celsius (0° C.) and an absolute pressure of 100,000 Pascals (100 kPa), respectively. One cost effective way to extract chemical energy from hydrogen is to burn it in internal combustion engines. However, conventional hydrogen internal combustion engines, such as those that premix hydrogen with air prior to ignition, suffer from low power density compared to diesel or gasoline engines with the same displacement volume. The premixed hydrogen engine also typically shows lower efficiency compared to diesel engines.

Introducing hydrogen directly into engine cylinders near the end of the compression stroke (that is, late cycle introduction of fuel) such that the hydrogen burns in a diffusion combustion mode improves the performance of hydrogen burning engines, increasing both the power density and efficiency compared to premixed hydrogen engines. As used herein, the diffusion combustion mode refers to combustion with a diffusion flame and is also known as diffusion-flame combustion. These types of late cycle, direct injection, gaseous fuel engines are currently employed for fueling with other types of gaseous fuel, notably natural gas. These late cycle, direct injection engines store the natural gas in liquefied form at cryogenic temperatures and employ a cryogenic pump to pressurize the natural gas to a pressure required to perform late cycle fuel injection, where an injection pressure of natural gas must overcome the pressure in the combustion chamber near the end of the compression stroke. Pressurizing liquefied natural gas to the injection pressure (for example, 300 bar) is relatively efficient compared to pressurizing natural gas in a gas form, since liquefied natural gas behaves more like an incompressible fluid such that it takes less energy to increase its pressure. As used herein, injection pressure of a fuel is the pressure of the fuel when it is injected into a combustion chamber, and a differential injection pressure is a difference between the injection pressure of the fuel and a pressure in the combustion chamber at the time of injection.

Hydrogen is more readily available as a compressed gas than as a liquefied gas such that there are advantages in fueling internal combustion engines from a supply of compressed hydrogen. The hydrogen gas is typically stored in compressed form at a pressure of 700 bar whereby high pressure, late cycle, direct injection can occur without having to pressurize the gas from the supply of compressed hydrogen while the supply pressure is between 700 bar and a lower pressure limit for late cycle fuel injection. When the supply pressure drops below the lower pressure limit, for example somewhere between 250 bar and 300 bar, an onboard compressor is required to pressurize the compressed hydrogen to at least the lower pressure limit to enable late cycle, direction injection of hydrogen. These compressors can be expensive and can consume a substantial amount of energy, increasing parasitic energy costs, which negatively impacts fuel economy. This problem is exacerbated if the initial pressure of compressed hydrogen is 350 bar instead of 700 bar, whereby the duty cycle of the onboard compressor will be dramatically increased as the onboard compressor is activated sooner and operated longer between refilling operations.

The state of the art is lacking in techniques for operating internal combustion engines when fueling with a fuel stored as a compressed gas. The present apparatus and method provide a technique for operating an internal combustion engine with multiple combustion modes.

### SUMMARY

An improved apparatus for operating an internal combustion engine in multiple combustion modes includes a gaseous-fuel supply storing gaseous fuel as a compressed gas having a gas storage pressure. There is a fuel injector in fluid communication with the gaseous-fuel supply and configured to inject gaseous fuel directly into a combustion chamber of the internal combustion engine at an injection pressure. A controller is operatively connected with the fuel injector and programmed to determine to operate the internal combustion engine in a first combustion mode or a second combustion mode. The internal combustion engine is operated in the first combustion mode when the injection pressure or the gas storage pressure is greater than or equal to a first-combustion-mode threshold pressure. The internal combustion engine is operated in the second combustion mode when the injection pressure or the gas storage pressure is less than the first-combustion-mode threshold pressure. In the first combustion mode, the controller is programmed to actuate the fuel injector to inject the gaseous fuel at a first injection timing during a compression stroke such that the gaseous fuel substantially burns by diffusion combustion; and in the second combustion mode, the controller is programmed to actuate the fuel injector to inject the gaseous fuel at a second injection timing during the compression stroke such that the gaseous fuel substantially burns by one of partially-premixed combustion and premixed combustion.

The gaseous fuel can be ignited by a pilot fuel. The first injection timing is between and including 30 crank angle degrees before top dead center in a compression stroke and 20 crank angle degrees after top dead center in an expansion stroke. The second injection timing is between and including 120 crank angle degrees before top dead center in a compression stroke and 30 crank angle degrees before top dead center in the compression stroke. The first-combustion-mode threshold pressure can be between a range of 250 bar and 300 bar. The first-combustion-mode threshold pressure is an injection pressure for the gaseous fuel whereby a demanded quantity of the gaseous fuel cannot be timely injected such that the demanded quantity substantially burns by diffusion combustion.

The apparatus can further include a pressure regulator fluidly receiving the gaseous fuel from the gaseous-fuel supply and fluidly supplying the gaseous fuel at a regulated pressure to the fuel injector. There can be included a compressor operatively connected with the controller for selectively pressurizing the gaseous fuel from the gaseous-fuel supply into the fuel injector, where the controller is programmed to command the compressor to pressurize the gaseous fuel when the gas storage pressure is less than a second-combustion-mode threshold pressure, where the second-combustion-mode threshold pressure is less than the first-combustion-mode threshold pressure. The second-combustion-mode threshold pressure can be an injection pressure whereby a demanded quantity of the gaseous fuel cannot be timely injected such that the demanded quantity substantially burns by partially-premixed combustion.

The controller can be further programmed to determine whether to operate the internal combustion engine in the first combustion mode, the second combustion mode, or a third combustion mode. The internal combustion engine can be operated in the third combustion mode when the injection pressure or the gas storage pressure is less than a second-combustion-mode threshold pressure. In the third combustion mode, the controller can be programed to actuate the fuel injector to inject the gaseous fuel at a third injection timing such that the gaseous fuel substantially burns by premixed combustion. The third injection timing can be before 120 crank angle degrees before top dead center in a compression stroke. Alternatively, or additionally, the third injection timing can begin during an intake stroke. The gaseous fuel can be ignited by a pilot fuel in the first combustion mode, the second combustion mode and the third combustion mode. The apparatus can further include a second fuel injector fluidly connected with the gaseous-fuel supply and injecting the gaseous fuel upstream of an intake valve of the combustion chamber, where the gaseous fuel can be injected by the second fuel injector during the third combustion mode. The gaseous fuel can be ignited by a pilot fuel in the first combustion mode and the second combustion mode, and the gaseous fuel can be ignited by another positive ignition source in the third combustion mode. The other positive ignition source can be one of a spark igniter or a glow plug.

The controller can be further programmed to determine to operate the internal combustion engine in the first combustion mode, the second combustion mode, or a fourth combustion mode. The internal combustion engine can be operated in the fourth combustion mode when the injection pressure or the gas storage pressure is less than a second-combustion-mode threshold pressure which is less than the first-combustion-mode threshold pressure. In the fourth combustion mode, the controller can be programmed to actuate the fuel injector to inject the gaseous fuel at a fourth injection timing such that the gaseous fuel mixes with a second fuel and forms a reactivity-controlled fuel/air mixture that substantially burns in a reactivity-controlled combustion mode. The second fuel can be a more reactive than the gaseous fuel. The fuel injector can be a dual fuel injector that introduces the gaseous fuel separately and independently from the second fuel. The second fuel can be a liquid fuel, such as diesel fuel.

The controller can be further programmed to determine to operate the internal combustion engine in the first combustion mode, the second combustion mode, a third combustion mode, or a fourth combustion mode. The internal combustion engine can operate in the third combustion mode or the fourth combustion mode when the injection pressure or the gas storage pressure is less than a second-combustion-mode threshold pressure. In the third combustion mode, the controller can be programmed to actuate the fuel injector to inject the gaseous fuel at a third injection timing such that the gaseous fuel substantially burns by premixed combustion; and in the fourth combustion mode, the controller can be programmed to actuate the fuel injector to inject the gaseous fuel at a fourth injection timing such that the gaseous fuel mixes with a second fuel and forms a reactivity-controlled fuel/air mixture that substantially burns in a reactivity-controlled combustion mode. The controller can be programmed to select the fourth combustion mode when the internal combustion engine is operating in a low load condition.

The gaseous-fuel supply can be filled to a gas storage pressure of 300 bar or greater. The gaseous fuel can be selected from the group consisting of biogas, methane, natural gas, hydrogen, and mixtures thereof.

An improved method for operating an internal combustion engine in multiple combustion modes includes storing a gaseous fuel as a compressed gas having a gas storage pressure; selectively injecting the gaseous fuel into a combustion chamber of the internal combustion engine; determining to operate the internal combustion engine in a first combustion mode or a second combustion mode, the internal combustion engine can be operated in the first combustion mode when an injection pressure of the gaseous fuel or the gas storage pressure is greater than or equal to a first-combustion-mode threshold pressure, the internal combustion engine can be operated in the second combustion mode when the injection pressure or the gas storage pressure is less than the first-combustion-mode threshold pressure; in the first combustion mode, injecting the gaseous fuel at a first injection timing during a compression stroke such that the gaseous fuel substantially burns by diffusion combustion; and in the second combustion mode, injecting the gaseous fuel at a second injection timing during the compression stroke such that the gaseous fuel substantially burns by one of partially-premixed combustion and premixed combustion.

The method can further include determining to operate the internal combustion engine in the first combustion mode, the second combustion mode, or a third combustion mode, the internal combustion engine can be operated in the third combustion mode when the injection pressure or the gas storage pressure is less than a second-combustion-mode threshold pressure; and in the third combustion mode, the method can include injecting the gaseous fuel at a third injection timing such that the gaseous fuel substantially burns by premixed combustion.

The method can further include determining to operate the internal combustion engine in the first combustion mode, the second combustion mode, or a fourth combustion mode, the internal combustion engine can be operated in the fourth combustion mode when the injection pressure or the gas storage pressure is less than the a second-combustion-mode threshold pressure; and in the fourth combustion mode, the method can include injecting the gaseous fuel at a fourth injection timing such that the gaseous fuel mixes with a second fuel and forms a reactivity-controlled fuel/air mixture that substantially burns in a reactivity-controlled combustion mode; where the second fuel is more reactive than the gaseous fuel.

The method can further include determining to operate the internal combustion engine in the first combustion mode, the second combustion mode, a third combustion mode, or a fourth combustion mode, the internal combustion engine can be operated in the third combustion mode or the fourth combustion mode when the injection pressure or the gas storage pressure is less than the a second-combustion-mode threshold pressure; in the third combustion mode, the method can include injecting the gaseous fuel at a third injection timing such that the gaseous fuel substantially burns by premixed combustion; and in the fourth combustion mode, the method can include injecting the gaseous fuel at a fourth injection timing such that the gaseous fuel mixes with a second fuel and forms a reactivity-controlled fuel/air mixture that substantially burns in a reactivity-controlled combustion mode.

### BRIEF DESCRIPTION OF THE DRAWINGS

FIG. 1 is a schematic view of an internal combustion engine according to an embodiment.

FIG. 2 is a cross-sectional view of a cylinder of the internal combustion engine of FIG. 1.

FIG. 3 is a schematic view of an internal combustion engine according to another embodiment.

FIG. 4 is a schematic view of an internal combustion engine according to another embodiment.

FIG. 5 is a cross-sectional view of a cylinder of an internal combustion engine according to another embodiment.

FIG. 6 is a chart view of fuel-injection mass-flow for fuel injectors of FIG. 1, FIG. 3, FIG. 4, or FIG. 5 for a late cycle, direct injection combustion mode according to an embodiment.

FIG. 7 is a chart view of fuel-injection mass-flow for fuel injectors of FIG. 1, FIG. 3, FIG. 4, or FIG. 5 for a mid-cycle, direct injection combustion mode according to an embodiment.

FIG. 8 is a chart view of fuel-injection mass-flow for fuel injectors of FIG. 1, FIG. 3,

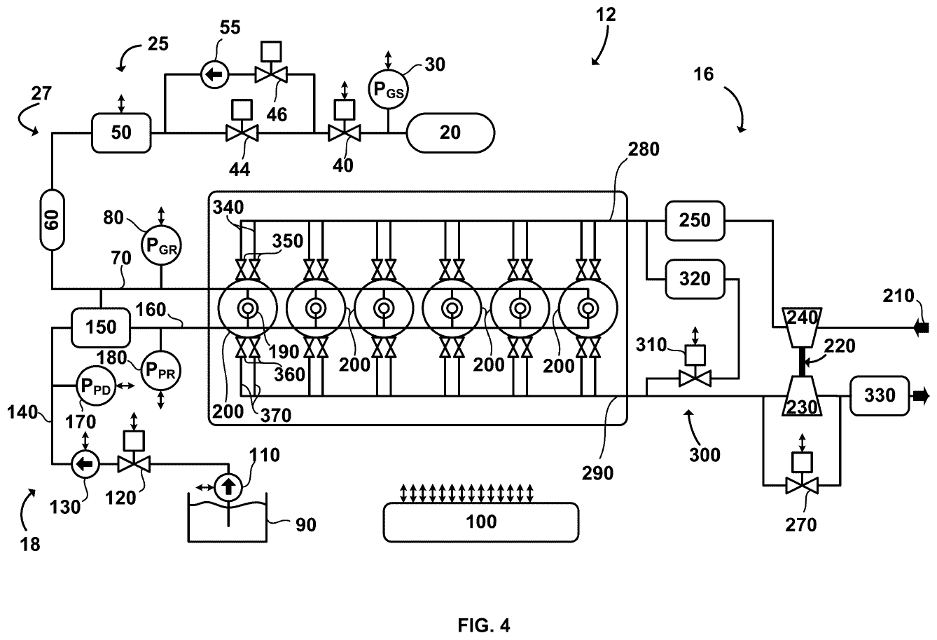

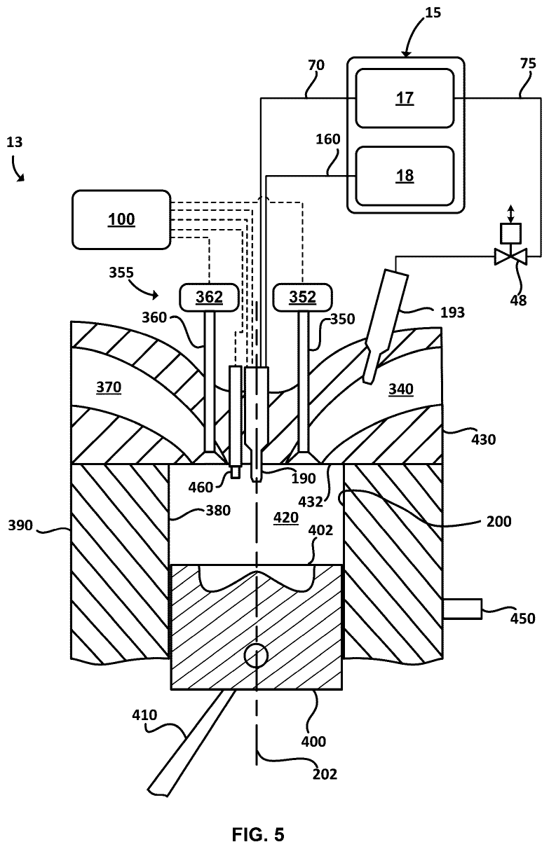

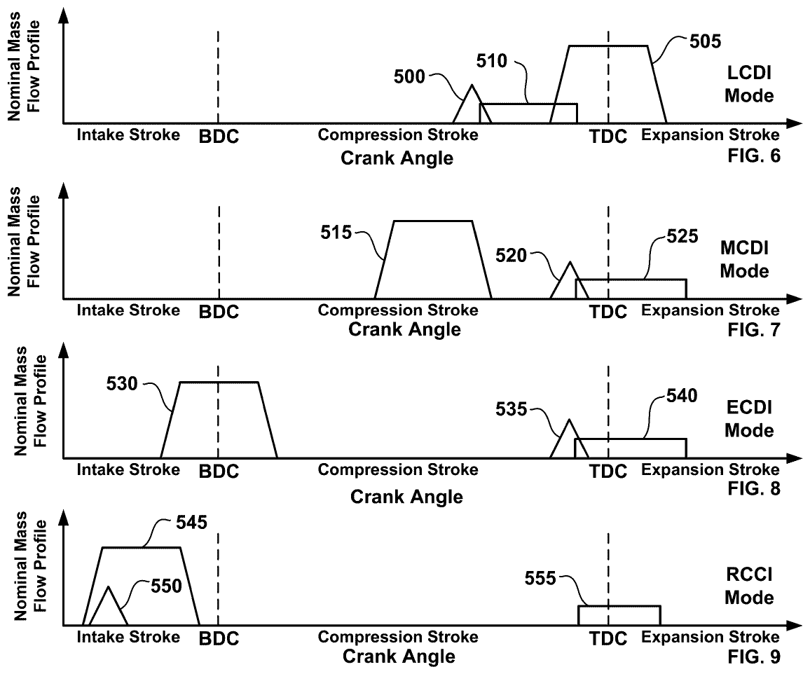

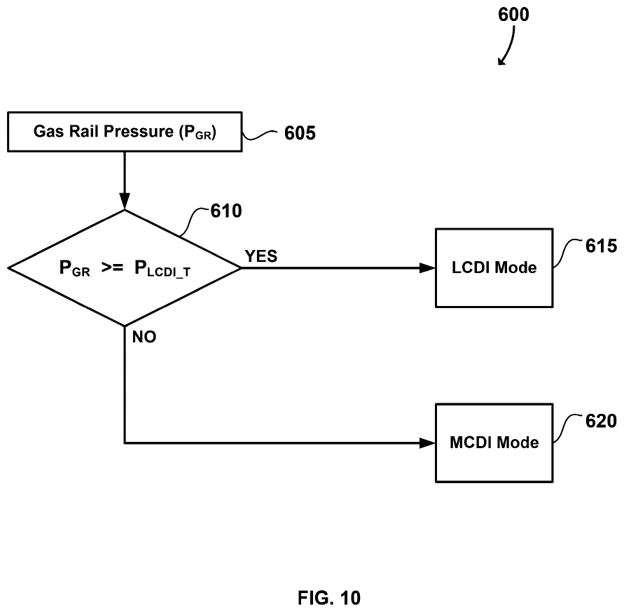

FIG. 4, or FIG. 5 for an early cycle, direct injection combustion mode according to an embodiment.

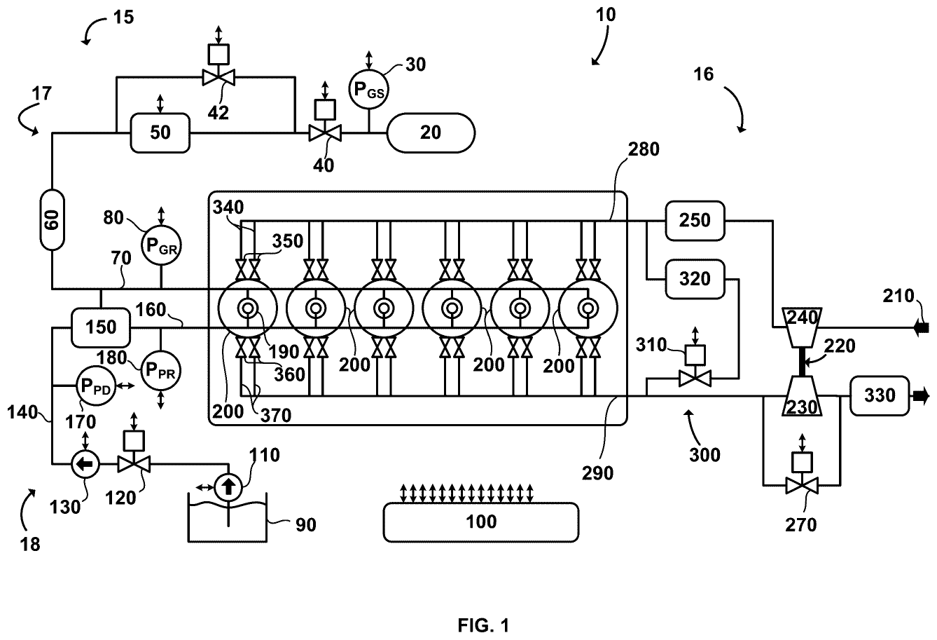

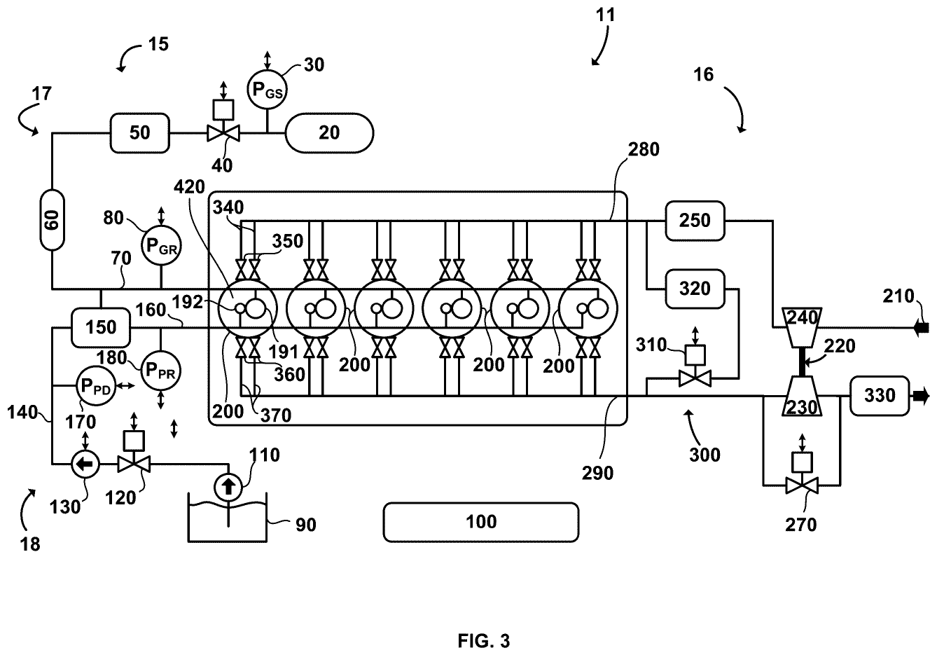

FIG. 9 is a chart view of fuel-injection mass-flow for fuel injectors of FIG. 1, FIG. 3, FIG. 4, or FIG. 5 for a reactivity-controlled compression ignition combustion mode according to an embodiment.

FIG. 10 is a flow chart view of a combustion mode selection algorithm for the internal combustion engine of FIG. 1, 3, or 4 according to an embodiment.

FIG. 11 is a flow chart view of a combustion mode selection algorithm for the internal combustion engine of FIG. 1, 3, or 4 according to an embodiment.

FIG. 12 is a flow chart view of a combustion mode selection algorithm for the internal combustion engine of FIG. 4 according to another embodiment.

FIG. 13 is a flow chart view of a combustion mode selection algorithm for the internal combustion engine of FIG. 1, 3, 4, or 5 according to another embodiment.

FIG. 14 is a flow chart view of a combustion mode selection algorithm for the internal combustion engine of FIG. 1, 3, 4, or 5 according to another embodiment.

### DETAILED DESCRIPTION

Referring to FIG. 1 there is shown a schematic view of internal combustion engine 10 according to an embodiment where only elements relevant to the disclosure of the present invention are illustrated, and other elements not illustrated in FIG. 1 that can be employed in internal combustion engines can also be employed by engine 10. Engine 10 can be for a vehicle, and can also be employed in marine, locomotive, mine haul, power generation, stationary, or other applications. Engine 10 includes fuel system 15 and air system 16 that supply fuel and air, respectively to the engine. Fuel system 15 can store, pressurize, regulate a pressure of and deliver fuel to engine 10. Air system 16 can compress and cool intake air, prepare air/exhaust-gas mixtures, and deliver air or air/exhaust-gas mixtures to engine 10. Fuel system 15 and air system 16 are now discussed in more detail.

Fuel system 15 includes gaseous-fuel system 17 and pilot-fuel system 18 in the illustrated embodiment, and each will now be described in turn. Gaseous-fuel system 17 can store the gaseous fuel, regulate a pressure of the gaseous fuel, and deliver the gaseous fuel to engine 10. Gaseous-fuel supply 20 stores the gaseous fuel as a compressed gas at a rated fill pressure. The rated fill pressure of gaseous-fuel supply 20 is defined as that gas storage pressure P_{GS} after gaseous-fuel supply 20 is filled to a full level, and in exemplary embodiments the rated fill pressure can be 350 bar or 700 bar; however, other rated fill pressures both lower and higher are contemplated. The rated fill pressure is typically lower than a rated pressure of gaseous-fuel supply 20, which is a maximum pressure of compressed gas that gaseous-fuel supply 20 can safely store. Gas storage pressure P_{GS} can be measured by gas-storage pressure sensor 30, which generates a signal representative of gas storage pressure P_{GS} that is received by controller 100 and can measure the gas storage pressure directly in gaseous-fuel supply 20 or in a delivery pipe supplying the gaseous fuel from gaseous-fuel supply 20. Although engine 10 can consume any type of gaseous fuel, hydrogen, methane, natural gas, or mixtures thereof are exemplary gaseous fuels. As used herein, the term gaseous fuel refers to one type of gaseous fuel or a mixture of gaseous fuels in any mixture ratio. Gas storage pressure P_{GS} can vary between the rated fill pressure and a lower-threshold gas storage pressure PLTGS, which is defined as a minimum value of the gas storage pressure P_{GS} below which engine 10 cannot operate at full load which is defined as the maximum rated power of the internal combustion engine. As will be described in more detail below, engine 10 can operate in multiple combustion modes, and values of the lower-threshold gas storage pressure PLTGS can vary depending upon the combustion mode that engine 10 is currently operating.

The gaseous fuel is fluidly communicated to pressure regulator 50 from gaseous-fuel supply 20 through shut-off valve 40. Pressure regulator 50 regulates gas rail pressure P_{GR} in gas rail 70. Accumulator 60 provides a predetermined volume of the gaseous fuel at gas rail pressure P_{GR} to reduce pressure fluctuations in gas rail 70 as engine 10 operates, and in other embodiments accumulator 60 can be a delivery pipe supplying gaseous fuel from pressure regulator 50 to gas rail 70. Gas rail pressure P_{GR} can be measured by gas-rail pressure sensor 80, which generates a signal representative of gas rail pressure P_{GR} that is received by controller 100 and can measure the gas rail pressure P_{GR} directly in gas rail 70, in accumulator 60, or a delivery pipe between pressure regulator 50 and gas rail 70. Pressure regulator 50 can selectively regulate gas rail pressure P_{GR} to two or more predetermined rail pressures and can be commanded by controller 100 to select which predetermined rail pressure to regulate gas rail pressure P_{GR} to in gas rail 70. In exemplary embodiments, pressure regulator 50 can employ mechanical pressure regulation or electronic pressure regulation. In other exemplary embodiments pressure regulator can be a fuel injector that is commanded by controller 100 to inject fuel into accumulator 60 and gas rail 70. Regulator-bypass valve 42 can be employed to deliver the gaseous fuel from gaseous-fuel supply 20 to gas rail 70 without regulating a pressure of the gaseous fuel, such that the gas rail pressure P_{GR} is equal to the gas supply pressure Pas. In other embodiments regulator-bypass valve 42 is not required such that the gaseous fuel is always pressure regulated, or pressure regulator 50 is not required such that the gaseous fuel is not pressure regulated.

Pilot-fuel system 18 can store a pilot fuel, pressurize the pilot fuel, regulate a pressure of the pilot fuel, and deliver the pilot fuel to engine 10. The pilot fuel is employed to ignite the gaseous fuel in engine 10 and is typically a liquid fuel, although it is not required to be a liquid fuel, and in the illustrated embodiment pilot-fuel system 18 is configured for a liquid fuel. A liquid fuel is any fuel that is in a liquid state at the standard temperature (0° C.) and pressure (100 kPa). Pilot-fuel supply 90 stores the pilot fuel substantially at atmospheric pressure. Gaseous fuels typically have a low cetane number and are difficult to auto-ignite in the pressure and temperature environment typically found in combustion chambers of internal combustion engines during a compression stroke. Accordingly, the pilot fuel is employed to ignite the gaseous fuel, where the pilot fuel has a cetane number high enough such that autoignition of the pilot fuel is robust and repeatable in the pressure and temperature environment typically found in combustion chambers during the compression stroke. An exemplary pilot fuel is diesel fuel, which is stored in liquid form substantially at atmospheric pressure in pilot-fuel supply 90; however, other pilot fuels are contemplated. Low pressure pump 110 pressurizes and fluidly transfers the pilot fuel out of pilot-fuel supply 90 and through shut-off valve 120. High pressure pump 130, which can include an inlet metering valve and a common rail pump, pressurizes the pilot fuel to pilot delivery pressure P_{PD} in delivery conduit 140. Pressure regulator 150 regulates pilot delivery pressure P_{PD} down to pilot rail pressure P_{PR} in pilot rail 160. In the illustrated embodiment, pressure regulator 150 regulates pilot rail pressure P_{PR} in pilot rail 160 with respect to gas rail pressure P_{GR} (known as pilot follows gas) such that a differential pressure between pilot rail pressure P_{PR} and gas rail pressure P_{GR} is within a predetermined range. The differential pressure between pilot rail pressure P_{PR} and gas rail pressure P_{GR} is known as system bias pressure. Pilot delivery pressure sensor 170 generates a signal representative of pilot delivery pressure P_{PD} that is received by controller 100. Pilot rail pressure sensor 180 generates a signal representative of pilot rail pressure P_{PR} that is received by controller 100. In other embodiments pilot rail pressure P_{PR} is equal to pilot delivery pressure P_{PD} and gas storage pressure P_{GS} can be regulated as a function of pilot rail pressure P_{PR} to gas rail pressure P_{GR} (known as gas follows pilot).

Gas rail 70 and pilot rail 160 deliver the gaseous fuel and the pilot fuel, respectively, to fuel injectors 190 associated with respective cylinders 200. In the illustrated embodiment there are six cylinders 200 and respective fuel injectors 190; however, in other embodiments there can be a single cylinder and injector or another plurality of cylinders and injectors. Each fuel injector 190 is a concentric needle, dual-fuel, in-cylinder injector that directly injects the gaseous fuel into cylinder 200 and directly injects the pilot fuel into cylinder 200 separately and independently of the gaseous fuel. Fuel injector 190 can be like fuel injectors disclosed in the Applicant's U.S. Pat. No. 10,294,908 issued on May 21, 2019, and/or U.S. Pat. No. 10,502,169 issued on Dec. 10, 2019.

Air system 16 fluidly communicates and conditions air from air intake 210 to intake manifold 280 that distributes the intake air to cylinders 200. Turbocharger 220 selectively pressurizes the intake air when exhaust gas is fluidly communicated through turbine 230 thereby driving compressor 240 to pressurize the intake air. Turbocharger 220 can be a variable geometry turbocharger, and in other embodiments can be a dual stage turbocharging system. Compressed intake air leaving an outlet of compressor 240 is elevated in temperature due to compression, compared to fresh intake air, and accordingly is communicated through charge air cooler 250 where it is cooled. Waste-gate valve 270 can be actuated by controller 100 between a closed position and a fully opened position, and to partially open positions therebetween, to allow at least a portion of exhaust gases to bypass turbine 230.

During some engine operating conditions, a portion of exhaust gases from cylinders 200 can be communicated to intake manifold 280 from exhaust manifold 290 through exhaust gas recirculation (EGR) system 300. Controller 100 commands EGR valve 310 between a closed position and an open position, and partially open positions therebetween, to control the EGR mass flow rate through EGR system 300, for a given back pressure in exhaust manifold 290. EGR cooler 320 reduces the temperature of exhaust gases to protect intake manifold 280 and to lower in-cylinder temperatures. In the illustrated embodiment at least a portion of exhaust gases from all cylinders 200 can be recirculated to intake manifold 280. In other embodiments any other EGR architecture can be employed, such as those that dedicate one or more cylinders, or one or more exhaust ports, to EGR. Exhaust gases not passing through EGR system 300 are communicated through turbine 230 and/or wastegate valve 270 to engine after-treatment system 330.

Intake air is fluidly communicated from intake manifold 280 through respective intake ports 340 and intake valves 350 to cylinders 200. Although the illustrated embodiment shows two intake valves 350 for each cylinder 200, in other embodiments there can be only one intake valve 350 or more than two intake valves 350 for each cylinder 200. Exhaust gases are fluidly communicated from cylinders 200 through respective exhaust valves 360 and exhaust ports 370 into exhaust manifold 290. Although the illustrated embodiment shows two exhaust valves 360 for each cylinder 200, in other embodiments there can be only one exhaust valve 360 or more than two exhaust valves 360 for each cylinder 200.

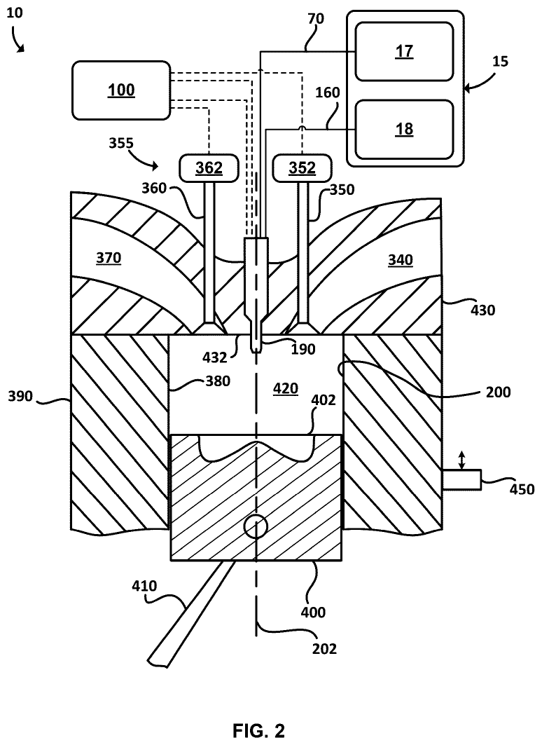

Referring now to FIG. 2, each cylinder 200, having longitudinal axis 202, is defined by inner bore surface 380 in engine block 390. For each cylinder 200 there is a piston 400 that reciprocates within the cylinder 200 and that is connected with a crankshaft (now shown) through crank arm 410 that turns reciprocal motion of piston 400 into rotational motion of the crankshaft. Combustion chamber 420 is defined by engine block 390, piston 400 and cylinder head 430. More particularly, combustion chamber 420 is defined by inner bore surface 380 of engine block 390, piston crown 402 of piston 400, and piston-facing surface 432 of cylinder head 430. Intake valves 350 and exhaust valves 360 can be actuated by valve actuators 352 and 362, respectively, and in the illustrated embodiment valve actuators 352 and 362 can be variable valve actuation (VVA) system 355 that is operatively connected with and commanded by controller 100 to adjust intake valve timing (IVT) of intake valve 350 and exhaust valve timing (EVT) of exhaust valve 360. Valve actuators 352 and 362 in VVA system 355 can employ camshaft-based systems or camless systems. Camshaft based systems can be valve timing control (VTC), also known as variable valve timing (VVT) systems that change the timing of the intake and exhaust valve events without significantly altering the lift. Alternatively, camshaft-based systems can be variable valve event and lift control, also known as variable valve lift (VVL) that can provide a discrete or continuous range of lift and/or duration control between two limits, which can allow modest adjustments in phasing. Camshaft based VVL and VTC systems can be combined to enable lift and timing control. Camless systems can include hydraulically actuated or electromagnetically actuated systems. Camless systems offer more flexibility compared to camshaft-based systems in valve lift and timing but can have an increased risk of interference between the intake or exhaust valve in the lifted position and the piston. VVA system 355 can be employed for internal EGR, also known as residual EGR, which is hot, in-cylinder EGR, in comparison to EGR system 300, which is an external EGR system (that can be either hot or cool depending upon how much EGR cooler 320 is employed to cool the exhaust gas). Internal EGR can be advantageous when the gaseous fuel comprises hydrogen where EGR system 300 can be deteriorated due to water condensation and corrosion. Knock sensor 450 can be employed to detect and control engine knock or preignition, particularly when internal combustion engine 10 is operated in a premixed combustion mode or a partially-premixed combustion mode. As used herein, the premixed combustion mode refers to combustion with a premixed flame and is also known as premixed-flame combustion. Partially-premixed combustion refers to combustion with a combination of diffusion-flame and premixed-flame, as will be described in more detail below. Knock sensor 450 emits signals representative of a level of knock and is operatively connected with controller 100 and can be part of a smart combustion sensor system that processes signals from the knock sensor 450 to determine combustion characteristics, which in turn can detect changes in fuel quality. Controller 100 can employ the smart combustion sensor to improve control of combustion in internal combustion engine 10 due to variations in fuel quality, particularly for gaseous fuels that can have wide variation in fuel quality such as natural gas. A preferred location for mounting knock sensor 450 is on a bearing cap (not shown) of internal combustion engine 10.

A compression ratio of internal combustion engine 10 and all other internal combustion engines disclosed herein can be a geometric compression ratio or an effective compression ratio. The geometric compression ratio is the maximum compression ratio achievable in a particular internal combustion engine and is defined as the ratio between a maximum volume of combustion chamber 420 when piston 400 is at or near bottom dead center when the intake valve 350 closes (during the intake stroke or the compression stroke) over a volume of combustion chamber 420 when piston 400 is at top dead center. The effective compression ratio is less than or equal to the geometric compression ratio, which can be achieved by adjusting intake valve closing timing using VVA (cither camshaft-based systems or camless systems) and can be defined as a ratio between a volume of combustion chamber 420 when intake valve 350 closes during the intake stroke or the compression stroke (where exhaust valve 360 is already closed) over a volume of combustion chamber 420 when piston 400 is at top dead center. The effective compression ratio can also take into account blowby of charge through piston rings (not shown), where the piston rings are disposed between piston 400 and inner bore surface 380 of cylinder 200 to seal combustion chamber 420. The geometric compression ratio and the available effective compression ratio values are programmed in controller 100 herein, whereby the controller knows the current compression ratio. The VVA system 355 can be employed to reduce the effective compression ratio to reduce the likelihood of knock when internal combustion engine 10 is operated in the premixed or the partially-premixed combustion mode.

Referring now to FIG. 3, there is shown internal combustion engine 11 that is like the previous embodiment where like parts between this and all other embodiments have like reference numerals and differences are discussed. Gaseous-fuel injector 191 and pilot-fuel injector 192 are separate in-cylinder fuel injectors that introduce gaseous fuel and pilot fuel, respectively directly into combustion chamber 420. Alternatively, in other embodiments, gaseous-fuel injector 191 and pilot-fuel injector 192 can be located within a common housing of a single, in-cylinder dual fuel injector.

In other embodiments, a compressor can be employed to pressurize the gaseous fuel as gas storage pressure P_{GS} declines below a threshold. Referring to FIG. 4, there is shown internal combustion engine 12 with fuel system 25 including gaseous-fuel system 27 and pilot-fuel system 18. Gaseous-fuel system 27 includes compressor 55 that can be commanded by controller 100 to pressurize the gaseous fuel from gaseous-fuel supply 20. Compressor-bypass valve 44 can be actuated by controller 100 to an open position to fluidly communicate the gaseous fuel from gaseous-fuel supply 20 around compressor 55, and to a closed position to fluidly communicate the gaseous fuel through the compressor. Compressor valve 46 can be employed to fluidly isolate compressor 55 from gaseous-fuel supply 20, although in other embodiments compressor valve 46 is not required. Similarly, in other embodiments shut-off valve 40 is not required since compressor-bypass valve 44 and compressor valve 46 together can provide a similar gaseous-fuel shut-off function.

In other exemplary embodiments, port fuel injection can complement the in-cylinder injectors 190, 191 and 192 in certain operating modes, as will be described in more detail below. Referring now to FIG. 5, there is shown internal combustion engine 13 that includes port injector 193 fluidly connected with gaseous-fuel system 17 to receive the gaseous fuel. In the illustrated embodiment, port fuel injector 193 is fluidly connected to gaseous-fuel system 17 through valve 48, both of which are operatively connected with and commanded by controller 100. Valve 48 can be commanded to a closed position when gas storage pressure P_{GS} or gas rail pressure P_{GR} allows for diffusion combustion and partially-premixed combustion in combustion chamber 420. Valve 48 can be commanded to an open position when gas storage pressure P_{GS} or gas rail pressure P_{GR} allows for premixed combustion but does not accommodate diffusion combustion and partially-premixed combustion in combustion chamber 420. Alternatively, valve 48 can be commanded to an open position for any gas storage pressure P_{GS} or gas rail pressure P_{GR}. Conduit 75 can be directly connected with gas rail 70 or conduit 75 can be connected to another pressure regulator (not shown) that regulates gas storage pressure P_{GS} down to a port-injection pressure PPI. In addition to pilot fuel igniting the gaseous fuel, under some circumstances igniter 460 can be employed to ignite the gaseous fuel. Igniter 460 is a positive ignition source other than pilot fuel, such as a spark plug, a glow plug, or other hot surface. The gaseous fuel can be selectively ignited by the pilot fuel or igniter 460 in internal combustion engine 13 as a function of gas storage pressure P_{GS} or gas rail pressure P_{GR}, as well as engine operating conditions. In other embodiments, fuel injectors 191 and 192 can be employed instead of fuel injector 190 in an internal combustion engine that also employs port fuel injector 193 and/or igniter 460.

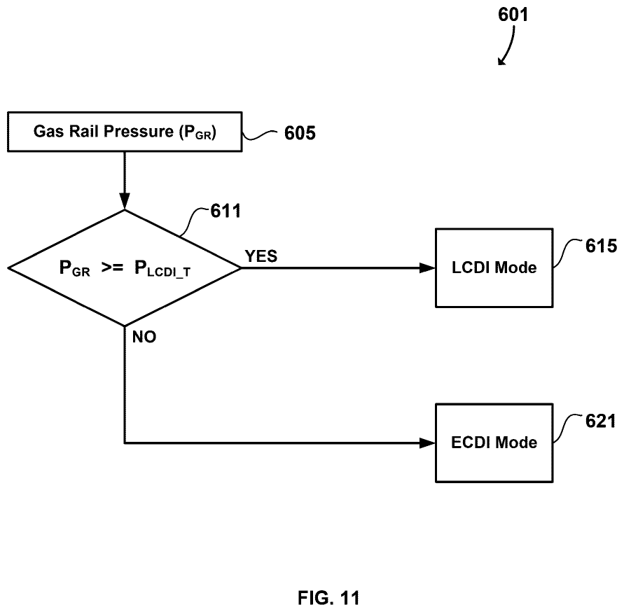

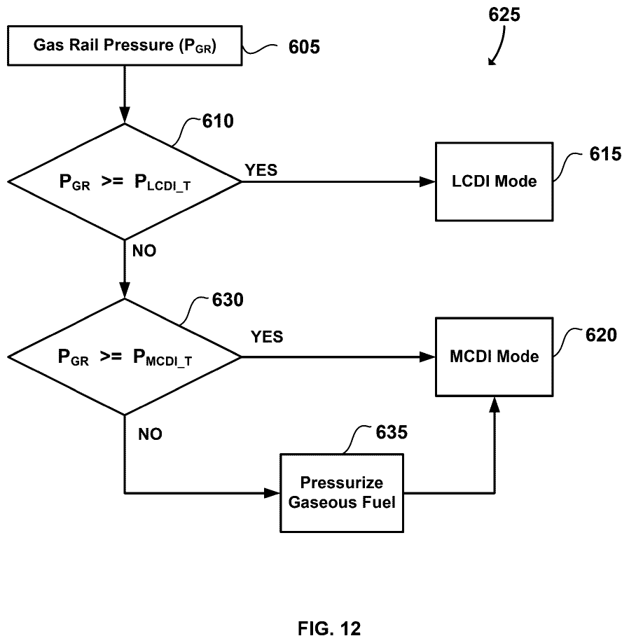

Internal combustion engines 10, 11, 12 and 13 can be operated in a variety of combustion modes that each burn fuel in combustion chamber 420 in diverse ways. With reference to FIG. 6, fuel-injection mass-flow for a late-cycle, direct injection (LCDI) combustion mode is illustrated where the fuel injected into combustion chamber 420 substantially burns with diffusion combustion. Pilot-injection mass flow 500 represents a nominal mass flow of pilot fuel injected into combustion chamber 420 and main-injection mass flow 505 represents a nominal mass flow of main fuel injected into combustion chamber 420 in the LCDI combustion mode. Pilot-injection mass flow 500 and main-injection mass flow 505 begin later during the compression stroke such that the pilot fuel and the gaseous fuel do not have time to premix and thereby substantially burn only with diffusion combustion. As used herein, the terms gaseous fuel and main fuel can be used interchangeably, as well as the terms gaseous-fuel-injection mass flow and main-injection mass flow. In the illustrated embodiment, pilot-injection mass flow 500 begins and completes during the compression stroke, before main-injection mass flow 505, which also begins during the compression stroke and can end during the expansion stroke (however, this is not a requirement). In other embodiments pilot-injection mass flow 500 can be overlapped with main-injection mass flow 505 and main-injection mass flow 505 can end during the compression stroke, provided in all cases the injected pilot fuel and main fuel substantially burn by diffusion combustion. In the LCDI combustion mode, the end of injection of the main fuel is typically later than start of ignition of the main fuel. A main injection window (as measured in crank angle degrees) during the LCDI combustion mode where main-injection mass flow 505 can begin and end is between 30 crank angle degrees (CA°) before top dead center (BTDC) during the compression stroke and 20 CA° after top dead center (ATDC) during the expansion stroke. An injection pressure for the gaseous fuel during the LCDI combustion mode can be at least 250 bar and as high as the rated fill pressure of gaseous-fuel supply 20. Exemplary injection pressures for the gaseous fuel are substantially 300 bar and substantially 500 bar. A global fuel/air equivalence ratio in combustion chamber 420 can be less than or equal to 0.75 in the LCDI combustion mode where both the gaseous fuel and the pilot fuel are included in the determination. Combustion in the LCDI combustion mode is substantially diffusion combustion such that the global fuel/air equivalence ratio is lean to achieve good mixing quality for diffusion combustion. Pilot ignition window 510 illustrates the range of crank angle degrees in which ignition of pilot fuel can occur with reference to pilot-injection mass flow 500, in the illustrated embodiment. Pilot ignition window 510 during the LCDI combustion mode can be between 15 CA° BTDC in the compression stroke and 15 CA° ATDC in the expansion stroke.

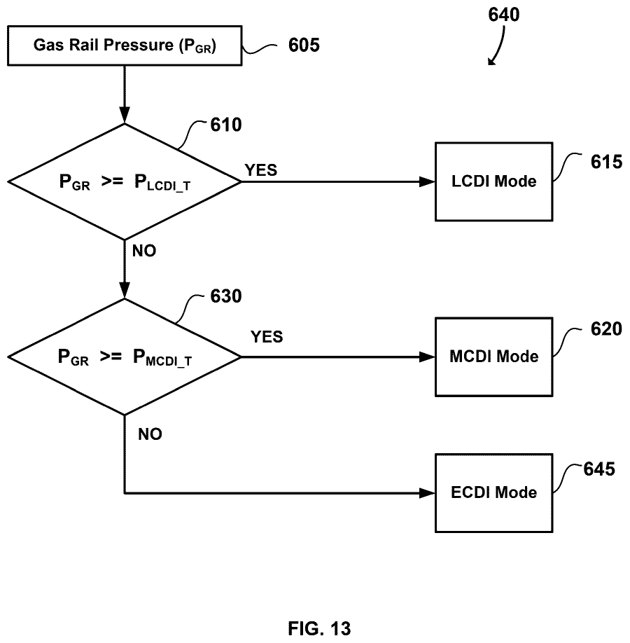

Referring now to FIG. 7, a mid-cycle, direct injection (MCDI) combustion mode is illustrated where at least the main fuel injected into combustion chamber 420 has some time to premix such that it forms a partially-premixed gaseous-fuel/air mixture that burns with both diffusion combustion and premixed-flame combustion, which is referred to collectively as the partially-premixed combustion mode. In the MCDI combustion mode, there are regions in combustion chamber 420 where a combustion rate is limited by a rate of diffusion and other regions where the combustion rate is controlled by the propagation of the flame. Main-injection mass flow 515 represents a nominal mass flow of main fuel injected into combustion chamber 420 and pilot-injection mass flow 520 represents a nominal mass flow of pilot fuel injected into combustion chamber 420 in the MCDI combustion mode. Main-injection mass flow 515 begins earlier during the compression stroke compared to both pilot-injection mass flow 500 and main-injection mass flow 505 in the LCDI combustion mode of FIG. 6, which allows the gaseous fuel injected due to main-injection mass flow 515 to partially premix with air. Pilot-injection mass flow 520 occurs later during the compression stroke near the time at which start of ignition of the partially-premixed gaseous-fuel/air mixture is desired. A main injection window during the MCDI combustion mode where main-injection mass flow 515 can begin and end is between 120 CA° BTDC during the compression stroke and 30 CA° BTDC during the compression stroke. End of injection of the main fuel typically occurs before start of ignition of the main fuel in the MCDI combustion mode. An injection pressure for the gaseous fuel during the MCDI combustion mode can be at least 100 bar, and although the injection pressure during the MCDI combustion mode can be as high as the rated fill pressure of gaseous-fuel supply 20 it typically isn't higher than a lower value (or a minimum value) of the main injection pressure during the LCDI combustion mode since the gaseous fuel is injected earlier during the compression stroke in the MCDI mode than in the LCDI mode whereby cylinder pressure during injection is less. An exemplary injection pressure range for the gaseous fuel during the MCDI combustion mode is between 100 bar and 200 bar. In an exemplary embodiment, when the injection pressure is 290 bar during the LCDI combustion mode, the injection pressure during the MCDI combustion mode can be 140 bar whereby engines 10, 11, 12, and 13 can be operated at full engine load in the MCDI combustion mode with little even negligible penalty on peak thermal efficiency. A global fuel/air equivalence ratio in combustion chamber 420 can be less than or equal to 0.75 in the MCDI combustion mode where both the gaseous fuel and the pilot fuel are included in the determination. Combustion in the MCDI combustion mode is partially premixed such that it operates with a lean value of the global fuel/air equivalence ratio to achieve improved combustion efficiency. Pilot ignition window 525 illustrates the range of crank angle degrees in which ignition of pilot fuel can occur with reference to pilot-injection mass flow 520, in the illustrated embodiment. Pilot ignition window 525 during the MCDI combustion mode can be between 15 CA° BTDC in the compression stroke and 15 CA° ATDC in the expansion stroke.

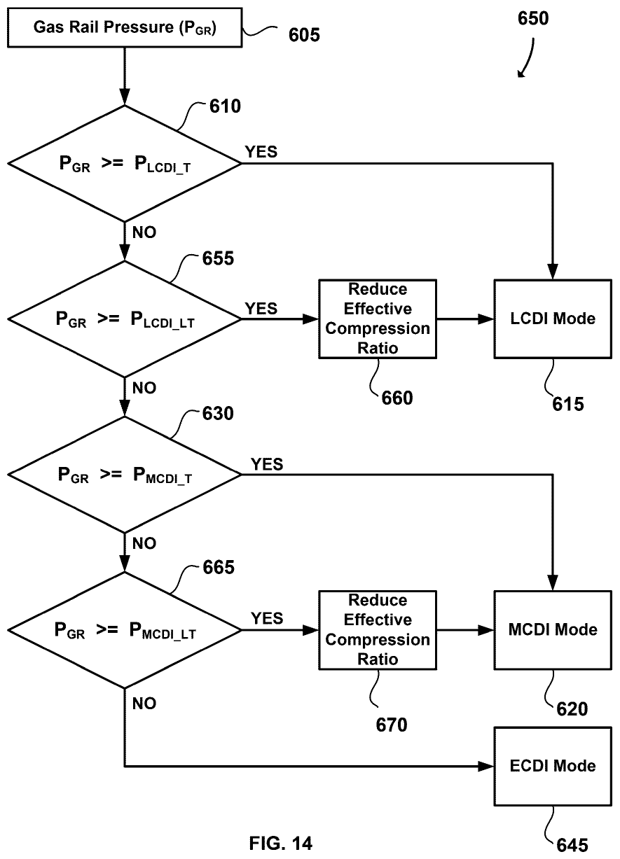

An early-cycle, direct injection (ECDI) combustion mode is illustrated in FIG. 8 where the main fuel injected into combustion chamber 420 has sufficient time to premix such that it forms a premixed gaseous-fuel/air mixture that substantially burns only with premixed-flame combustion, where the equivalence ratio of the gaseous-fuel/air mixture supports flame propagation (so it can't be too lean). Main-injection mass flow 530 represents a nominal mass flow of main fuel injected into combustion chamber 420 and pilot-injection mass flow 535 represents a nominal mass flow of pilot fuel injected into combustion chamber 420 in the ECDI combustion mode. In the illustrated embodiment main-injection mass flow 530 begins during the intake stroke and ends early during the compression stroke. However, this is not a requirement and in other embodiments main-injection mass flow 530 can both begin and end early during the compression stroke provided there is sufficient time for the premixed gaseous-fuel/air mixture to form before it is ignited by the combustion of the pilot fuel. Alternatively, in other embodiments main-injection mass flow 530 can both begin and end during the intake stroke. The end of injection of the main fuel occurs before an early phase in the compression stroke, such as before 90 CA° BTDC in the compression stroke. Pilot-injection mass flow 535 has similar timing compared to the MCDI combustion mode, where the pilot-injection mass flow begins later during the compression stroke. In an exemplary embodiment, a main injection window during the ECDI combustion mode where main-injection mass flow 530 can begin and end is between intake valve closing (IVC) and 120 CA° BTDC during the compression stroke. Air is not displaced in combustion chamber 420 by the main fuel when the main fuel is injected after the intake valve closes. An amount of oxidizer (that is, oxygen) is reduced when air is displaced from combustion chamber 420, which reduces a maximum power that the internal combustion engine can produce from combustion when a fuel/air equivalence ratio is stoichiometric. An injection pressure for the gaseous fuel during the ECDI combustion mode can be at least 20 bar, and although the injection pressure during the ECDI combustion mode can be as high as the rated fill pressure of gaseous-fuel supply 20 it typically is not higher than a minimum value of the main injection pressure during the MCDI combustion mode. An exemplary injection pressure range for the gaseous fuel is between 20 bar and 100 bar. A global fuel/air equivalence ratio in combustion chamber 420 can be less than or equal to 1.00 in the ECDI combustion mode where both the gaseous fuel and the pilot fuel are included in the determination. The global fuel/air equivalence ratio in the ECDI combustion mode can be the stoichiometric ratio (φ=1.00) since the fuel/air mixture can be fully premixed. Pilot ignition window 540 illustrates the range of crank angle degrees in which ignition of pilot fuel can occur with reference to pilot-injection mass flow 535, in the illustrated embodiment. Pilot ignition window 540 during the ECDI combustion mode can be between 15 CA° BTDC in the compression stroke and 15 CA° ATDC in the expansion stroke.

With reference to FIG. 9, a reactivity-controlled compression ignition (RCCI) combustion mode is illustrated where a reactivity-controlled fuel/air mixture auto-ignites in combustion chamber 420. In contrast to flame propagation in premixed combustion in the ECDI combustion mode, the reactivity-controlled fuel/air mixture can be so lean that a flame cannot propagate, but rather the RCCI combustion mode relies on the reactivity-controlled fuel/air mixture reaching the autoignition temperature to ignite and burn in a “controlled knock” type of combustion, such that the fuel burns in a reactivity-controlled combustion mode. The reactivity-controlled fuel/air mixture is formed by mixing a high reactivity fuel and a low reactivity fuel, where in the illustrated embodiment the high reactivity fuel is the pilot fuel and the low reactivity fuel is the gaseous fuel, and where the reactivity-controlled fuel/air mixture can have a very lean equivalence ratio to obtain high thermal efficiency and low nitrogen oxides (NOx) simultaneously. The high reactivity fuel and the low reactivity fuel can be mixed in real time such that the fuel mixture behaves as a single, moderately reactive fuel. Accordingly, the pilot fuel and the gaseous fuel are injected simultaneously or at least both early during the engine cycle, for example sometime during the intake stroke or early during the compression stroke to form a substantially uniform mixture. With the early injection of pilot fuel and the gaseous fuel, the fuel mixture is allowed to ‘cook’ during the compression stroke prior to ignition where the fuel reacts with oxygen molecules creating intermediate species and creating heat that, in a cascading fashion, leads to a faster reaction rate and promotes ignition of the fuel/air mixture. Main-injection mass flow 545 represents a nominal mass flow of main fuel injected into combustion chamber 420 and pilot-injection mass flow 550 represents a nominal mass flow of pilot fuel injected into combustion chamber 420 in the RCCI combustion mode. In the illustrated embodiment, main-injection mass flow 545 and pilot-injection mass flow 550 occur during the intake stroke (both beginning and ending during the intake stroke) and where pilot-injection mass flow 550 occurs during main-injection mass flow 545. However, this is not a requirement, and in other embodiments main-injection mass flow 545 and pilot-injection mass flow 550 can occur during the compression stroke (both beginning and/or ending during the compression stroke), pilot-injection mass flow 550 can overlap either the beginning or the ending of main-injection mass flow 545, and pilot-injection mass flow 550 can follow main-injection mass flow 545 (no overlap) provided that in all circumstances the reactivity-controlled fuel/air mixture is formed. In an exemplary embodiment, a main injection window during the RCCI combustion mode where main-injection mass flow 545 can begin and end is between intake valve closing (IVC) and 30 CA° BTDC during the compression stroke. An injection pressure for the gaseous fuel during the RCCI combustion mode can be at least 20 bar, and although the injection pressure during the RCCI combustion mode can be as high as the rated fill pressure of gaseous-fuel supply 20 it typically is comparable to the high end of injection pressure found in the MCDI mode since the main injection window can extend to 30° BTDC during the compression stroke like in the MCDI mode. An exemplary injection pressure range for the gaseous fuel is between 20 bar and 200 bar. A global fuel/air equivalence ratio in combustion chamber 420 can be less than or equal to 0.5 in the RCCI combustion mode where both the gaseous fuel and the pilot fuel are included in the determination. The RCCI combustion mode is typically employed at low to mid load due to a limit in a rate of heat release associated with the premixed compression-ignition combustion. Low loads being less than 50% maximum rated load. Mid load being 50% maximum rated load. The RCCI combustion mode employs a global fuel/air equivalence ratio that is extra lean compared to the other modes to reduce the amount of nitrogen oxides (NOx) produced. Ignition window 555 represents where ignition of the reactivity-controlled fuel/air mixture can occur, where in an exemplary embodiment ignition window 555 can be between 15 CA° BTDC during the compression stroke and ending 15 CA° ATDC during the expansion stroke. Comparing the two premixed combustion modes, combustion efficiency can be greater in the RCCI combustion mode compared to the ECDI combustion mode.

The LCDI, MCDI, ECDI, and RCCI combustion modes can also be referred to as the LCDI, MCDI, ECDI, and RCCI operating modes, respectively in which, for example, the internal combustion engines 10, 11, 12, 13 can operate. The LCDI operating mode burns the gaseous fuel with diffusion-flame combustion. The MCDI operating mode burns the gaseous fuel with partially-premixed combustion. The ECDI operating mode burns the gaseous fuel with premixed-flame combustion. The RCCI operating mode burns the gaseous fuel in a reactivity-controlled combustion mode. In other exemplary embodiments, split injections can be employed for gaseous-fuel injection in any of the LCDI, MCDI, ECDI, and RCCI combustion modes, where the gaseous fuel is injected into combustion chamber 420 in two or more separate injections. In at least the LCDI and MCDI combustion modes, split injections can distribute the heat release over a wide range thereby reducing peak cylinder pressures and temperatures, which can help to reduce NOx generation. Start of combustion of the gaseous fuel can begin later in the MCDI and ECDI combustion modes compared to the LCDI combustion mode. The MCDI and ECDI combustion modes can have a high value of a heat release rate, and higher cycle-to-cycle variation in the heat release rate, in comparison to the LCDI combustion mode due to the nature of diffusion combustion. A timing for the start of combustion can be retarded in the MCDI and ECDI combustion modes compared to the LCDI combustion mode to reduce the likelihood of exceeding the peak cylinder pressure limit. An amount of EGR can be adjusted (that is, increased) to reduce the likelihood of knock in the MCDI and ECDI combustion modes, and for NOx reduction in the LCDI, MCDI, and ECDI combustion modes. Preferably, an injection pressure of the pilot fuel remains substantially the same in all the combustion modes (LCDI, MCDI, ECDI and RCCI) such that the pilot fuel, which is typically a liquid fuel like diesel, is atomized efficiently. Fuel injector 190 accordingly is tolerant to the wide pressure difference between the pilot fuel and the gaseous fuel as the injection pressure of the gaseous fuel decreases. In some embodiments, during at least a portion of the ECDI and RCCI combustion modes, the gaseous fuel can be introduced upstream of intake valve 350 (for example, injected into intake port 340 by port fuel injector 193, seen in FIG. 5). Design requirements on fuel injectors 190 and 191 to inject the gaseous fuel between the rated fill pressure (that can be as high as 700 bar) and a minimum value of the injection pressure range (for example, 20 bar) in the ECDI and RCCI combustion modes are relaxed when port fuel injector 193 is employed to inject the gaseous fuel at the lower injection pressure range. Moreover, instead of employing the pilot fuel to ignite the gaseous fuel in the ECDI combustion mode, igniter 460 (seen in FIG. 5) can be employed. In the LCDI, MCDI, and ECDI combustion modes the purpose of injecting the pilot fuel is to ignite and combust after a short ignition delay (between the pilot injecting timing and start of ignition of the pilot fuel) for the purpose of igniting the gaseous fuel. For example, the ignition delay of the pilot fuel can be 200-400 microseconds. Accordingly, the pilot fuel is injected into combustion chamber 420 close to the desired start of combustion of the gaseous fuel in the LCDI, MCDI, and ECDI combustion modes such that the pilot ignition windows 510, 525, and 540 immediately follow pilot-injection mass flow 500, 520, and 535, respectively. In contrast, in the RCCI combustion mode the purpose of injecting the pilot fuel is to begin the process of creating the reactivity-controlled fuel/air mixture, and not to ignite after a short ignition delay. Accordingly, pilot fuel is injected well before the desired start of combustion of the reactivity-controlled fuel/air mixture. In this regard the injection timing for the pilot fuel is not indicative with start of combustion in the RCCI combustion mode, unlike how it is indicative with start of combustion in the LCDI, MCDI, and ECDI combustion modes. The start of ignition timing of the reactivity-controlled fuel/air mixture is more difficult to control than the start of ignition timing of the gaseous fuel in the LCDI, MCDI, and ECDI combustion modes. The start of ignition timing in the RCCI combustion mode can be influenced (that is, roughly controlled) by varying the quantity of pilot fuel injected (the high reactivity fuel).

Referring to FIG. 10, combustion mode selection algorithm 600 is illustrated where the combustion mode of internal combustion engine 10, 11, 12, or 13 is selected based on gas rail pressure P_{GR}. Combustion mode selection algorithm 600 and all other combustion mode selection algorithms disclosed herein can be programmed into and performed by controller 100. In step 605, gas rail pressure P_{GR} is determined and in step 610 gas rail pressure P_{GR} is compared to an LCDI-threshold pressure P_{LCDI_T}. In step 615, the LCDI combustion mode is employed when gas rail pressure P_{GR} is greater than or equal to the LCDI-threshold pressure P_{LCDI_T}. The LCDI-threshold pressure P_{LCDI_T} is that injection pressure of the gaseous fuel above which the injection pressure is high enough to timely inject the demanded quantity of gaseous fuel during the injection window defined by main-injection mass flow 505 seen in FIG. 6 such that when the gaseous fuel is ignited it substantially burns with diffusion combustion, and when the injection pressure of the gaseous fuel is less than the LCDI-threshold pressure P_{LCDI_T}, the demanded quantity of gaseous fuel cannot be timely injected (at least for higher loads) during the injection window defined by main-injection mass flow 505 such that it substantially burns with diffusion combustion. There can also be emissions above desired levels when the gaseous-fuel injection pressure is less than the LCDI-threshold pressure PLCDI_T. When the gaseous fuel is hydrogen, the level of NOx emissions may be adversely affected, and when the gaseous fuel is natural gas, the level of unburned hydrocarbons and carbon monoxide may increase whereas NOx may decrease. The injection pressure of the gaseous fuel is equal to the gas rail pressure P_{GR}. In step 620, the MCDI combustion mode is employed when gas rail pressure P_{GR} is less than the LCDI-threshold pressure P_{LCDI_T}. Gas storage pressure P_{GS} has dropped to a level that cannot support the LCDI combustion mode without downstream pressurization, which is not employed in the combustion mode selection algorithm 600, when gas rail pressure P_{GR} drops to the LCDI-threshold pressure P_{LCDI_T}. Internal combustion engines 10, 11, 12, or 13 can continue to operate in the MCDI combustion mode until gas rail pressure P_{GR} reaches an MCDI-threshold pressure P_{MCDI_T} after which point the injection pressure of the gaseous fuel is not high enough to timely inject the gaseous fuel during the injection window defined by main-injection mass flow 515 (seen in FIG. 7) in the compression stroke such that the gaseous fuel substantially burns with partially-premixed combustion. Additionally, the injection window defined by main-injection mass flow 515 (seen in FIG. 7) is limited on the leading edge by the knock limit of internal combustion engines 10, 11, 12, or 13, where the injection timing must be advanced when the gaseous-fuel injection pressure is decreased to allow sufficient time for fuel injection, which will undesirably increase the knock probability in the engine. There can also be emissions above desired levels as discussed above with respect to the LCDI-threshold pressure P_{LCDI_T}. Gas rail pressure P_{GR} can be regulated (when pressure regulator 50 is employed) to the LCDI-threshold pressure P_{LCDI_T} (or the LCDI-threshold pressure P_{LCDI_T} plus a pressure margin) when operating in the LCDI combustion mode and to the MCDI-threshold pressure P_{MCDI_T} (or the MCDI-threshold pressure P_{MCDI_T} plus a pressure margin) when operating in the MCDI combustion mode, although other regulated pressures and even unregulated pressures are possible, whereby as gas storage pressure P_{GS} drops at some point pressure regulator 50 can no longer maintain pressure regulation at those pressures. In alternative embodiments, instead of comparing gas rail pressure P_{GR} to the LCDI-threshold pressure P_{LCDI_T}, the gas storage pressure Pas can be interchangeably compared to the LCDI-threshold pressure P_{LCDI_T} in step 610. The MCDI combustion mode can have higher indicated thermal efficiency and lower NOx than the LCDI combustion mode with reduced rail pressure, but in terms of combustion control, the MCDI combustion mode is more difficult and more prone to abnormal combustion (for example, knock). When engines 10, 11, 12, and 13 operated with a fixed compression ratio engine, using a compression ratio of substantially 15 is preferable for allowing a balance of indicated thermal efficiencies for the LCDI and MCDI combustion modes. This was surprising since a typical compression ratio for the LCDI combustion mode previously was 16.8. The reduced fixed compression ratio of 15 also offers safer operation (for ECDI) than the baseline 16.8 compression ratio. For a variable CR engine, the goal is to allow the LCDI combustion mode with supply pressure as low as possible before switching to ECDI. There again we found that with 15:1 compression ratio, we can drop the peak cylinder pressure (compared to that with the baseline CR) and allow a lower pressure LCDI and achieve good thermal efficiency when switching to ECDI. On the other hand, the advantage of going from 15:1 to 13:1 CR is not as clear as that from 17:1 to 15:1.

Alternatively, the operating combustion mode can be switched to the ECDI combustion mode instead of the MCDI combustion mode when it is no longer advantageous or possible to operate in the LCDI combustion mode. Referring now to FIG. 11, combustion mode selection algorithm 601 is illustrated where the combustion mode of internal combustion engine 10, 11, 12, or 13 is selected based on gas rail pressure P_{GR}. In step 611 gas rail pressure P_{GR} is compared to the LCDI-threshold pressure P_{LCDI_T}. In step 615, the LCDI combustion mode is employed when gas rail pressure P_{GR} is greater than or equal to the LCDI-threshold pressure P_{LCDI_T}. In step 621, the ECDI combustion mode is employed when gas rail pressure P_{GR} is less than the LCDI-threshold pressure P_{LCDI_T}. Gas storage pressure P_{GS} has dropped to a level that cannot support the LCDI combustion mode without downstream pressurization, which is not employed in the combustion mode selection algorithm 601, when gas rail pressure P_{GR} drops to the LCDI-threshold pressure P_{LCDI_T}. Internal combustion engines 10, 11, 12, or 13 can continue to operate in the ECDI combustion mode until gas rail pressure P_{GR} reaches an ECDI-threshold pressure PECDI T after which point the injection pressure of the gaseous fuel is not high enough to inject the gaseous fuel during the intake and/or compression strokes such that the gaseous fuel substantially burns only with premixed combustion. Gas rail pressure P_{GR} can be regulated (when pressure regulator 50 is employed) to the LCDI-threshold pressure P_{LCDI_T} when operating in the LCDI combustion mode and to the ECDI-threshold pressure P_{MCDI_T} when operating in the MCDI combustion mode, although other regulated pressures and even unregulated pressures are possible, whereby as gas storage pressure P_{GS} drops at some point pressure regulator 50 can no longer maintain pressure regulation at those pressures. In alternative embodiments, instead of comparing gas rail pressure P_{GR} to the LCDI-threshold pressure P_{LCDI_T}, the gas storage pressure P_{GS} can be interchangeably compared to the LCDI-threshold pressure P_{LCDI_T} in step 611. A lower compression ratio and higher levels of EGR may be employed in the ECDI combustion mode compared to those levels used in the MCDI combustion mode to reduce the likelihood of knock. In other embodiments, instead of employing pilot fuel injections to ignite the main fuel, a spark igniter can be employed to ignite the gaseous fuel in both the LCDI and ECDI combustion modes.

Referring to FIG. 12, combustion mode selection algorithm 625 is illustrated where the combustion mode of internal combustion engine 12 is selected based on gas rail pressure P_{GR}. Combustion mode selection algorithm 625 is like algorithm 600 and only the differences are discussed. In step 610, algorithm 625 proceeds to step 630 when gas rail pressure P_{GR} is less than the LCDI-threshold pressure P_{LCDI_T}. In step 630, gas rail pressure P_{GR} is compared to the MCDI-threshold pressure P_{MCDI_T}, and when the gas rail pressure P_{GR} is greater than or equal to the MCDI-threshold pressure P_{MCDI_T} the MCDI mode is selected in step 620, and when the gas rail pressure P_{GR} is less than the MCDI-threshold pressure P_{MCDI_T} the gaseous fuel from gaseous-fuel supply 20 is pressurized before it is delivered to gas rail 70. Gas storage pressure P_{GS} has dropped to a level that cannot support the MCDI mode when gas rail pressure P_{GR} drops to the MCDI-threshold pressure P_{MCDI_T}. In step 635, controller 100 closes compressor-bypass valve 44, opens compressor valve 46 and actuates compressor 55 to pressurize the gaseous fuel such that gas rail pressure P_{GR} is greater than or equal to the MCDI-threshold P_{MCDI_T}. In alternative embodiments, instead of comparing gas rail pressure P_{GR} to the LCDI-threshold pressure P_{LCDI_T} (in step 610) and the MCDI-threshold pressure PMCDIT (in step 630), the gas storage pressure P_{GS} can be interchangeably compared to the LCDI-threshold pressure PLCDIT and the MCDI-threshold pressure P_{MCDI_T}. In still further embodiments, compressor 55 can be actuated to extend the range of the LCDI combustion mode as well. For example, when the gas storage pressure P_{GS} drops below the LCDI-threshold pressure P_{LCDI_T}, compressor 55 can pressurize the gaseous fuel from gaseous-fuel supply 20 until the gas storage pressure P_{GS} reaches an LCDI-lower-threshold pressure P_{LCDI_LT}. However, the compressor would need to be rated for higher pressure operation and the parasitic energy cost would be greater to pressurize the gaseous fuel above the LCDI-threshold pressure P_{LCDI_T} compared to pressurizing the gaseous fuel above the MCDI-threshold pressure P_{MCDI_T}.

Referring now to FIG. 13, combustion mode selection algorithm 640 is illustrated where the combustion mode of internal combustion engine 10, 11, 12, or 13 is selected based on gas rail pressure P_{GR}. Combustion mode selection algorithm 640 is like algorithms 600 and 625 and only the differences are discussed. In step 630, gas rail pressure P_{GR} is compared to the MCDI-threshold pressure P_{MCDI_T}, and when the gas rail pressure P_{GR} is less than the MCDI-threshold pressure P_{MCDI_T} the ECDI combustion mode is selected in step 645. Gas storage pressure P_{GS} has dropped to a level that cannot support the MCDI mode without downstream pressurization of the gaseous fuel, which is not employed in the current embodiment, when gas rail pressure P_{GR} drops to the MCDI-threshold pressure P_{MCDI_T}. Internal combustion engine 10, 11, 12, or 13 can continue to operate in the ECDI combustion mode until gas rail pressure P_{GR} reaches an ECDI-threshold pressure PECDI T at which point the injection pressure of the gaseous fuel is not high enough to inject the gaseous fuel, or at least a sufficient amount of the gaseous fuel for a given engine demand during the intake and/or compression stroke such that the gaseous fuel substantially burns with premixed combustion. Gas rail pressure P_{GR} can be regulated (when pressure regulator 50 is employed) to the ECDI-threshold pressure PECDI T when operating in the ECDI combustion mode, although other regulated pressures and even unregulated pressures are possible, whereby as gas storage pressure P_{GS} drops at some point pressure regulator 50 can no longer maintain pressure regulation at those pressures. In alternative embodiments, algorithm 640 can enter the RCCI combustion mode in step 645 instead of entering the ECDI combustion mode, or can selectively switch between the ECDI combustion mode and the RCCI combustion mode as a function of engine operating conditions while operating internal combustion engines 10, 11, or 13 when gas rail pressure P_{GR} or gas storage pressure P_{GS} is below the MCDI-threshold pressure P_{MCDI_T}. The RCCI combustion mode can be advantageous during lower load conditions (a lower load condition is for example, below 50% of the full load), particularly but not exclusively when the gaseous fuel comprises hydrogen. In other embodiments, compressor 55 can be employed to extend the range of operating in the MCDI combustion mode before entering the ECDI combustion mode, like step 635 in algorithm 625 of FIG. 12. In alternative embodiments, instead of comparing gas rail pressure P_{GR} to the LCDI-threshold pressure P_{LCDI_T} (in step 610) and the MCDI-threshold pressure P_{MCDI_T} (in step 630), the gas storage pressure P_{GS} can be interchangeably compared thereto.

The LCDI-threshold pressure P_{LCDI_T} that defines a lower limit for the gas rail pressure P_{GR} in the LCDI combustion mode is a function of the effective compression ratio. Also, the MCDI-threshold pressure P_{MCDI_T} that defines a lower limit for the gas rail pressure P_{GR} in the MCDI combustion mode is also a function of the effective compression ratio. Accordingly, the effective compression ratio can be adjusted to extend the range of internal combustion engines 10, 11, 12, or 13 operating in either the LCDI combustion mode or the MCDI combustion mode. Referring now to FIG. 14, combustion mode selection algorithm 650 is illustrated where the combustion mode of internal combustion engine 10, 11, 12, or 13 is selected based on gas rail pressure P_{GR}. In step 610, when the gas rail pressure P_{GR} is less than the LCDI-threshold pressure P_{LCDI_T}, the gas rail pressure is then compared to LCDI-lower-threshold pressure P_{LCDI_LT} in step 655. The intake valve closing (IVC) timing is adjusted in step 660 to reduce the effective compression ratio when the gas rail pressure P_{GR} is greater than or equal to the LCDI-lower-threshold pressure P_{LCDI_LT}. In an exemplary embodiment, intake valve 350 (seen in FIG. 2) typically closes early during the compression stroke such that the IVC timing is retarded in step 660 such that intake valve 350 closes later during the compression stroke whereby the effective compression ratio is reduced. Internal combustion engines 10, 11, 12 or 13 can be operated in an Atkinson cycle or a Miller cycle when the effective compression ratio is reduced, where the effective compression ratio is less than an effective expansion ratio. Injection quantity and timing of the gaseous fuel and the pilot fuel can be adjusted as a function of the effective compression ratio in the LCDI combustion mode of step 615. Algorithm 650 proceeds to step 630 when the gas rail pressure P_{GR} is less than the LCDI-lower-threshold pressure P_{LCDI_LT} in step 655. In step 630, when the gas rail pressure P_{GR} is less than the MCDI-threshold pressure P_{MCDI_T}, the gas rail pressure is then compared to MCDI-lower-threshold pressure P_{MCDI_LT} in step 665. The IVC timing is adjusted in step 670 to reduce the effective compression ratio when the gas rail pressure P_{GR} is greater than or equal to the MCDI-lower-threshold pressure P_{MCDI_LT}. In an exemplary embodiment, intake valve 350 (seen in FIG. 2) typically closes early during the compression stroke such that the IVC timing is retarded in step 670 whereby intake valve 350 closes later during the compression stroke thereby the effective compression ratio is reduced. Injection quantity and timing of the gaseous fuel and the pilot fuel can be adjusted as a function of the effective compression ratio in the MCDI combustion mode of step 620. The ECDI combustion mode is entered in step 645 when gas rail pressure P_{GR} is less than the MCDI-lower-threshold pressure P_{MCDI_LT} in step 665. Internal combustion engines 10, 11, 12, or 13 can operate with a base level of EGR in step 615 of the LCDI combustion mode and can operate with an increased level of EGR compared to the base level in step 620 of the MCDI combustion mode and in step 645 of the ECDI combustion mode. The increased level of EGR in the MCDI and ECDI combustion modes can help to reduce the likelihood of knock. In alternative embodiments, instead of comparing gas rail pressure P_{GR} to the LCDI-threshold pressure P_{LCDI_T} (in step 610), the LCDI-lower-threshold pressure P_{LCDI_LT} (in step 655), the MCDI-threshold pressure P_{MCDI_T} (in step 630), and the MCDI-lower-threshold pressure P_{MCDI_LT}, (in step 665), the gas storage pressure P_{GS} can be interchangeably compared thereto.

An advantage of combustion mode selection algorithms 600, 601, 640, and 650 is that they do not require a compressor to pressurize the gaseous fuel to operate the internal combustion engines 10 and 11. This reduces the complexity and cost of the underlying gaseous-fuel system 17 and reduces the parasitic losses (associated with a compressor) of operating the internal combustion engines. An advantage of combustion mode selection algorithm 625, which employs compressor 55 to pressurize the gaseous fuel at least part of the time, is the internal combustion engine 12 can consume more of the gaseous fuel stored in the gaseous-fuel supply 20 compared to internal combustion engines 10 and 11 since the compressor can increase the pressure of the gaseous fuel stored at lower pressures in the gaseous-fuel supply than what would be acceptable for algorithms 600, 601, 640, and 650 to operate. Additionally, the involvement of compressor 55 is reduced when combustion mode selection algorithm 625 is employed with internal combustion engine 12 compared to previous internal combustion engines that are fueled with a gaseous fuel stored as a compressed gas.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. An apparatus for operating an internal combustion engine in multiple combustion modes comprising
a gaseous-fuel supply storing gaseous fuel as a compressed gas having a gas storage pressure;
a fuel injector in fluid communication with the gaseous-fuel supply and configured to inject gaseous fuel directly into a combustion chamber of the internal combustion engine at an injection pressure; and
a controller operatively connected with the fuel injector and programmed to
determine to operate the internal combustion engine in a first combustion mode or a second combustion mode,
the internal combustion engine is operated in the first combustion mode when the injection pressure or the gas storage pressure is greater than or equal to a first-combustion-mode threshold pressure,
the internal combustion engine is operated in the second combustion mode when the injection pressure or the gas storage pressure is less than the first-combustion-mode threshold pressure;
in the first combustion mode, actuate the fuel injector to inject the gaseous fuel at a first injection timing during a compression stroke such that the gaseous fuel substantially burns by diffusion combustion; and
in the second combustion mode, actuate the fuel injector to inject the gaseous fuel at a second injection timing during the compression stroke such that the gaseous fuel substantially burns by one of partially-premixed combustion and premixed combustion.

2. (canceled)

3. The apparatus as claimed in claim 1, wherein the first injection timing is between and including 30 crank angle degrees before top dead center in a compression stroke and 20 crank angle degrees after top dead center in an expansion stroke; and/or wherein the second injection timing is between and including 120 crank angle degrees before top dead center in a compression stroke and 30 crank angle degrees before top dead center in the compression stroke.

4. (canceled)

5. The apparatus as claimed in claim 1, wherein the first-combustion-mode threshold pressure is between a range of 250 bar and 300 bar; and/or
wherein the first-combustion-mode threshold pressure is an injection pressure for the gaseous fuel whereby a demanded quantity of the gaseous fuel cannot be timely injected such that the demanded quantity substantially burns by diffusion combustion.

6. (canceled)

7. The apparatus as claimed in claim 1, further comprising a pressure regulator fluidly receiving the gaseous fuel from the gaseous-fuel supply and fluidly supplying the gaseous fuel at a regulated pressure to the fuel injector; and/or further comprising a compressor operatively connected with the controller for selectively pressurizing the gaseous fuel from the gaseous-fuel supply into the fuel injector, the controller programmed to command the compressor to pressurize the gaseous fuel when the gas storage pressure is less than a second-combustion-mode threshold pressure, wherein the second-combustion-mode threshold pressure is less than the first-combustion-mode threshold pressure.

8. (canceled)

9. The apparatus as claimed in claim 7, wherein the second-combustion-mode threshold pressure is an injection pressure whereby a demanded quantity of the gaseous fuel cannot be timely injected such that the demanded quantity substantially burns by partially-premixed combustion.

10. The apparatus as claimed in claim 1, wherein the controller is further programmed to
determine to operate the internal combustion engine in the first combustion mode, the second combustion mode, or a third combustion mode,
the internal combustion engine is operated in the third combustion mode when the injection pressure or the gas storage pressure is less than a second-combustion-mode threshold pressure; and
in the third combustion mode, actuate the fuel injector to inject the gaseous fuel at a third injection timing such that the gaseous fuel substantially burns by premixed combustion.

11. The apparatus as claimed in claim 10, wherein the third injection timing is before 120 crank angle degrees before top dead center in a compression stroke; and/or wherein the third injection timing begins during an intake stroke.

12. (canceled)

13. The apparatus as claimed in claim 10, wherein the gaseous fuel is ignited by a pilot fuel in the first combustion mode, the second combustion mode and the third combustion mode.

14. The apparatus as claimed in claim 10, further comprising a second fuel injector fluidly connected with the gaseous-fuel supply and injecting the gaseous fuel upstream of an intake valve of the combustion chamber, the gaseous fuel injected by the second fuel injector during the third combustion mode.

15. The apparatus as claimed in claim 10, wherein the gaseous fuel is ignited by a pilot fuel in the first combustion mode and the second combustion mode, and the gaseous fuel is ignited by another positive ignition source in the third combustion mode.

16. The apparatus as claimed in claim 15, wherein the other positive ignition source is one of a spark igniter or a glow plug.

17. The apparatus as claimed in claim 1, wherein the controller is further programmed to
determine to operate the internal combustion engine in the first combustion mode, the second combustion mode, or a fourth combustion mode,
the internal combustion engine is operated in the fourth combustion mode when the injection pressure or the gas storage pressure is less than a second-combustion-mode threshold pressure which is less than the first-combustion-mode threshold pressure; and
in the fourth combustion mode, actuate the fuel injector to inject the gaseous fuel at a fourth injection timing such that the gaseous fuel mixes with a second fuel and forms a reactivity-controlled fuel/air mixture that substantially burns in a reactivity-controlled combustion mode; wherein the second fuel is more reactive than the gaseous fuel.

18. The apparatus as claimed in claim 17, wherein the fuel injector is a dual fuel injector that introduces the gaseous fuel separately and independently from the second fuel; and/or wherein the second fuel is a liquid fuel.

19. (canceled)

20. The apparatus as claimed in claim 1, wherein the controller is further programmed to
determine to operate the internal combustion engine in the first combustion mode, the second combustion mode, a third combustion mode, or a fourth combustion mode,
the internal combustion engine is operated in the third combustion mode or the fourth combustion mode when the injection pressure or the gas storage pressure is less than a second-combustion-mode threshold pressure;
in the third combustion mode, actuate the fuel injector to inject the gaseous fuel at a third injection timing such that the gaseous fuel substantially burns by premixed combustion; and
in the fourth combustion mode, actuate the fuel injector to inject the gaseous fuel at a fourth injection timing such that the gaseous fuel mixes with a second fuel and forms a reactivity-controlled fuel/air mixture that substantially burns in a reactivity-controlled combustion mode.

21. The apparatus as claimed in claim 20, wherein the controller is programmed to select the fourth combustion mode when the internal combustion engine is operating in a low load condition.

22. The apparatus as claimed in claim 1, wherein the gaseous-fuel supply is filled to a gas storage pressure of 300 bar or greater; and/or wherein the gaseous fuel is selected from the group consisting of methane, natural gas, hydrogen, and mixtures thereof; and/or wherein the gaseous fuel is ignited by a pilot fuel.

23. (canceled)

24. A method for operating an internal combustion engine in multiple combustion modes comprising
storing a gaseous fuel as a compressed gas having a gas storage pressure;
selectively injecting the gaseous fuel into a combustion chamber of the internal combustion engine;
determining to operate the internal combustion engine in a first combustion mode or a second combustion mode,
the internal combustion engine is operated in the first combustion mode when an injection pressure of the gaseous fuel or the gas storage pressure is greater than or equal to a first-combustion-mode threshold pressure,
the internal combustion engine is operated in the second combustion mode when the injection pressure or the gas storage pressure is less than the first-combustion-mode threshold pressure;
in the first combustion mode, injecting the gaseous fuel at a first injection timing during a compression stroke such that the gaseous fuel substantially burns by diffusion combustion; and
in the second combustion mode, injecting the gaseous fuel at a second injection timing during the compression stroke such that the gaseous fuel substantially burns by one of partially-premixed combustion and premixed combustion.

25. The method as claimed in claim 24, further comprising
determining to operate the internal combustion engine in the first combustion mode, the second combustion mode, or a third combustion mode,
the internal combustion engine is operated in the third combustion mode when the injection pressure or the gas storage pressure is less than a second-combustion-mode threshold pressure; and
in the third combustion mode, injecting the gaseous fuel at a third injection timing such that the gaseous fuel substantially burns by premixed combustion.

26. The method as claimed in claim 24, further comprising
determining to operate the internal combustion engine in the first combustion mode, the second combustion mode, or a fourth combustion mode,
the internal combustion engine is operated in the fourth combustion mode when the injection pressure or the gas storage pressure is less than a second-combustion-mode threshold pressure; and
in the fourth combustion mode, injecting the gaseous fuel at a fourth injection timing such that the gaseous fuel mixes with a second fuel and forms a reactivity-controlled fuel/air mixture that substantially burns in a reactivity-controlled combustion mode;
wherein the second fuel is more reactive than the gaseous fuel.

27. The method as claimed in claim 24, further comprising
determining to operate the internal combustion engine in the first combustion mode, the second combustion mode, a third combustion mode, or a fourth combustion mode,
the internal combustion engine is operated in the third combustion mode or the fourth combustion mode when the injection pressure or the gas storage pressure is less than a second-combustion-mode threshold pressure;
in the third combustion mode, injecting the gaseous fuel at a third injection timing such that the gaseous fuel substantially burns by premixed combustion; and
in the fourth combustion mode, injecting the gaseous fuel at a fourth injection timing such that the gaseous fuel mixes with a second fuel and forms a reactivity-controlled fuel/air mixture that substantially burns in a reactivity-controlled combustion mode.
